(19) United States
(12) Patent Application Publication
(10) Pub. No.: US 2016/0317908 A1
(43) Pub. Date: Nov. 3, 2016

(54) WORD GAME AND SYSTEM AND METHODS FOR PLAYING THE WORD GAME

(71) Applicant: Dwayne Scott Hughes, Lawrenceville, GA (US)

(72) Inventor: Dwayne Scott Hughes, Lawrenceville, GA (US)

(21) Appl. No.: 15/206,910

(22) Filed: Jul. 11, 2016

Related U.S. Application Data
(63) Continuation of application No. 14/587,344, filed on Dec. 31, 2014, now abandoned.

(51) Int. Cl. A63F 3/04; A63F 13/25; A63F 3/00; A63F 13/20

(52) U.S. Cl. CPC A63F 3/0421; A63F 3/0423; A63F 13/20; A63F 13/25; A63F 3/00643; A63F 2003/0426; A63F 2003/00996

(57) ABSTRACT

A first set of letters may be assigned to a first player who may be prompted to form a first word using at least one of the first set of letters. A validity of the first word formed by the first player may be determined. When the first word is valid, a flag may be moved from a first position to a second position towards a first finish line based on the first word formed by the first player. If the second position is not beyond the first finish line, the second player may be prompted to form a subsequent word using a last letter of the first word and at least one of a second set of letters. The flag may be moved, based on the subsequent word formed by the second player, to a subsequent position towards a second finish line associated with the second player.

### RELATED APPLICATIONS

This application is a continuation of U.S. patent application Ser. No. 14/587,344, filed Dec. 31, 2014, which is incorporated by reference in its entirety into this application.

### BACKGROUND

Word games generally include one or more players prompted to form one or more words. For example, in crosswords, a player may be prompted to form words using a set of conditions. Player, in the crossword, may further be involved in manipulating lettered tiles in contiguous linear sequences. Each tile typically may bear one letter and each letter is assigned a point value for scoring purposes. Players begin with a certain number of tiles, they draw new tiles at the end of each turn to replenish tiles played on the game board, and the object of the game is to accumulate maximum point scores by incorporating high-value tiles into words. The crossword game typically ends when a player exhausts his or her inventory of tiles. There is no other criterion for judging and scoring a word other than board position and correct spelling of the word.

### BRIEF DESCRIPTION OF DRAWINGS

The accompanying drawings, which are incorporated in and constitute a part of this disclosure, illustrate various embodiments of the present disclosure. In the drawings:

FIG. 1 is a diagram illustrating embodiments of an environment for playing a word game;

FIG. 2 is a diagram illustrating embodiments of a user interface for playing a word game;

FIG. 3 is a system for playing a word game;

FIG. 4 is a flow diagram illustrating a method for playing a word game; and

FIG. 5 is a flow diagram illustrating a method for generating a definition for a word.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

In an embodiment, the disclosure provides a word game. The word game may be played by a single player or multiple players. Each player may be assigned a set of letters and prompted to form a word on a game board. A first player may form a first word and points may be provided to the first player based on the first word formed by the first player. A flag may be moved from a neutral point towards a finish line associated with the first player on a number line. The letters of the first word formed by the first player may be removed except a last letter of the word. A second player may be prompted to form a second word using the last letter from the first word and his set of letters. Points may be provided to the second player based on the second word formed by the second player. The flag may be moved, based on the points earned by the second player, towards the finish line associated with the second player on the number line. When the flag reaches the finish line, the player associated with that finish line may be declared as a winner of that game. The word game is described in detail in the following sections of the disclosure with reference to various diagrams.

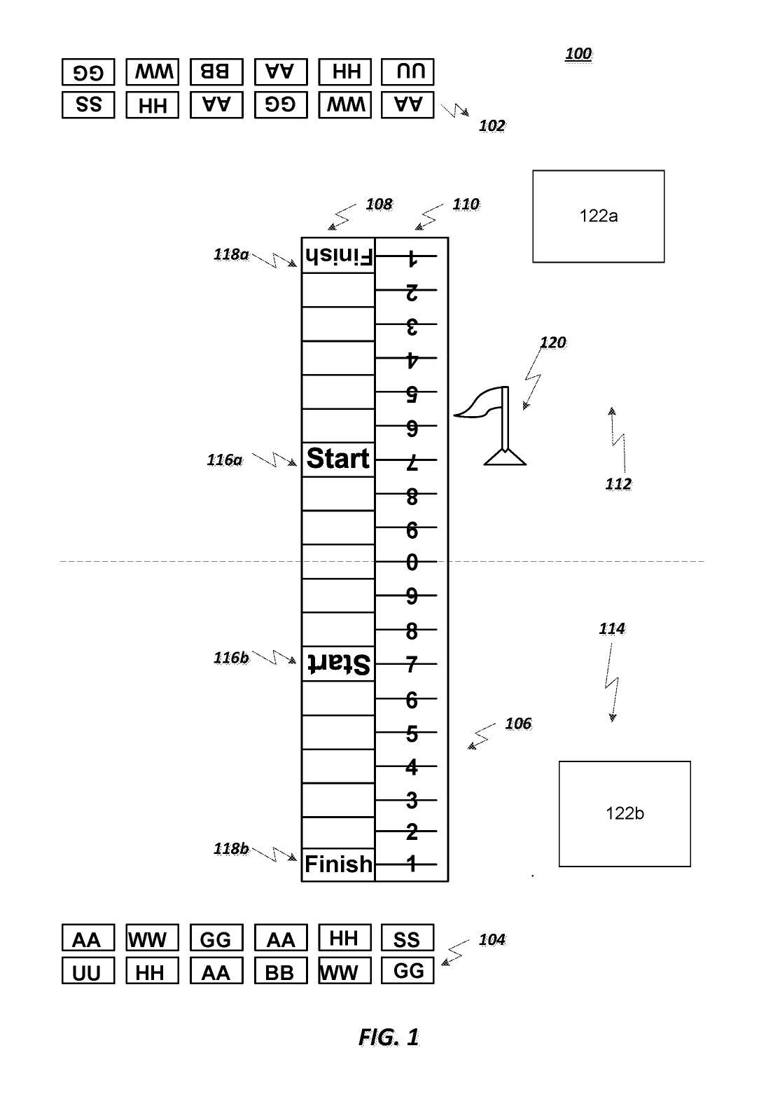

FIG. 1 is a diagram illustrating embodiments of a game environment 100 on which the word game may be played. As shown in FIG. 1, game environment 100 may include a first letter grid 102, a second letter grid 104, and a game board 106. First letter grid 102 may be used by a first player to hold his first set of letters , and second letter grid 104 may be used by the second player to hold his second set of letters . The first set of letters may be a set of alphabets drawn by the first player from a group of alphabets. Similarly, the second set of letters may be another set of alphabets drawn by the second player from the group of alphabets. For example, at a beginning of the word game, each of the first player and the second player may be prompted to randomly draw a predetermined number of letters from the group. The players may be asked to draw alternatively letters one-by-one or draw all of their predetermined number of letters at once. In an embodiment, the first set of letters and the second set of letters may be predefined or pre-assigned by a third party, such as a game conductor or a computer. Letter grids 102, 104 may allow free and fluid movement of letters at different positions and to game board 106. For example, letter grids 102, 104 may allow players to fluidly interchange positions of individual letters or a set of letters.

In an embodiment, the letters are designed to be visible to both the first player and the second player. For example, the letters on first letter grid 102 may be visible to both the first player and the second player. Similarly, the letters on second letter grid 104 may be visible to both the first player and the second player. The letters may be of lenticular print or in shape of a pyramid or a cone.

Game board 106 may be rectangular in shape and may include at least two distinct sections. For example, as shown in FIG. 1, game board 106 may include a first section 108 and a second section 110. First section 108 and second section 110 may be created by drawing a first line through the center of game board 106 in a first direction. The first direction may be a vertical direction or a horizontal direction. For example, and as shown in FIG. 1, game board 106 may be divided vertically with a left half forming first section 108 and a right half forming second section 110.

First section 108 may further be divided into multiple blocks which may be used by the players to arrange the letters to form words. For example, first section 108 may include an odd number of blocks. Two blocks, equidistant from a central block may be marked as start blocks 116. For example, start block 116a may be associated with a first player and start block 116b may be associated with the second player. In one example embodiment, players may be prompted to form their words starting from their respective start blocks 116. In another example embodiment, the first player may be prompted to form his word from the central block.

In an embodiment, start blocks 116 may be indicated at the beginning of the word game. For example, the start blocks 116 may be indicated by a marker, such as a color marker. The markers may be removed after the initiation of the word game. In another embodiment, the letters may be moved fluidly in first section 108. For example, placements of letters may be changed fluidly in first section 108. Similarly, the letters may be moved fluidly from letter grids 102, 104 to first section 108. In an embodiment, the word formed on first section 108 and the markers in first section 108 may be of lenticular print, and may be visible to both the first and second players.

Second section 110 may include a number line. The number line may have a neutral position and increasing numbers in both directions from the neutral position. The neutral position (also referred to as a starting position) may be marked with the number zero or number 8. The number line may have two finish lines 118 in both directions, equidistant from the neutral position. Each of the finish lines 118 may be associated with a player. For example, finish line 118a may be associated with the first player and finish line 118b may be associated with the second player. In an embodiment, the neutral position and finish lines 118 may be indicated by a marker, such as a color marker. The markers for finish lines 118 may be introduced after a first move from a first player or after removal of the markers for start blocks 116. In an embodiment, the markers for start blocks 116 may be moved to act as the markers for finish lines 118 after the initiation of the word game. In an embodiment, the numbers and the markers in the second section 110 may be lenticular print and be visible from any direction.

In an embodiment, game board 106 may further include a third section 112 and a fourth section 114. Third section 112 and fourth section 114 may be created by drawing a second line through the center of game board 106 in a second direction perpendicular to the first direction. For example, as shown in FIG. 1, an upper half of game board 106 may be designated as third section 112 and a lower half may be designated as fourth section 114. Third section 112 may be associated with and used by the first player and fourth section 114 may be associated with and used by the second player. Each of third section 112 and fourth section 114 may include one of start blocks 116 and one of finish lines 118. In an embodiment, third section 112 may include a statistics (“stats”) block 122a and fourth section 114 may include a stats block 122b. Stats blocks 122 may display statistics associated with the first player and the second player respectively. For example, the displayed statistics may include a rank of the plyers, such as a group rank, a city rank, a state rank, a country rank, and the worldwide rank. The displayed statistics may further include game related statistics such as an average length of the words formed by the players, an average time taken per turn by the players. In an embodiment, game board 106 may include a global stats block configured to display the global statistics for the word game. For example, the global statistics such as the highest ranked player, the most point earned by a single player, and the most medallions earned a single player.

Game board 106 may further include a flag 120. Flag 120 may be used to indicate the latest score of the word game. For example, flag 120 positioned on the number line of second section 110 may indicate the latest score in the game. If flag 120 is in third section 112, the first player may be determined to be leading or winning the word game. Similarly, if flag 120 is in fourth section 114, the second player may be determined to be leading or winning the word game. Flag 120 may be moved in player's direction based on the word formed by the player. For example, if the first player forms a four letter valid word, flag 120 may be moved by four places in the direction of the first player from a current position. At the beginning of the game, flag 120 may be placed at the center of second section 110, indicating a score of zero. When flag 120 reaches finish line 118, the game may be determined to be over and the player associated with the finish line may be declared as the winner of the word game.

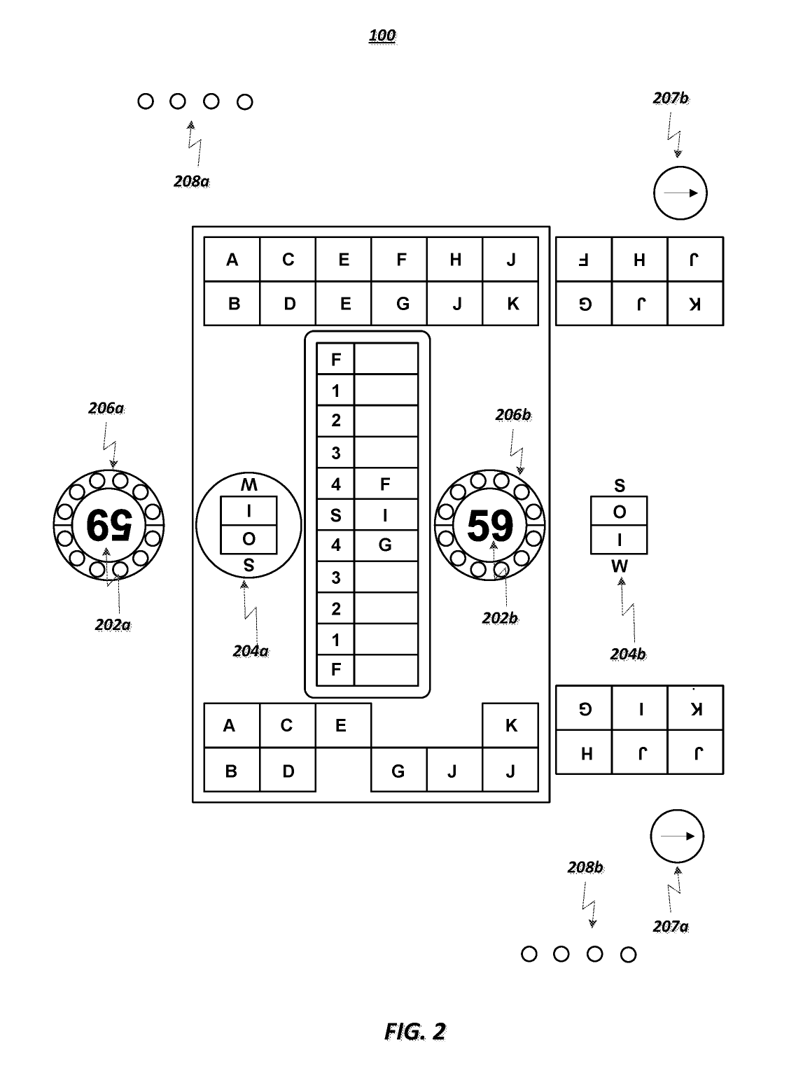

Game environment 100 may further include additional elements not shown in FIG. 1. These additional elements may be selected by the players based on mutual agreement at beginning of the game. For example, and as shown in FIG. 2, game environment 100 may include a first time counter 202a and a second time counter 202b (collectively referred as time counters 202), a first misspelled counter 204a and a second misspelled counter 204b (collectively referred to as misspelled counters 204), a first set of medallions 206a and a second set of medallions 206b (collectively referred to as medallions 206), a first send button 207a and a second send button 207b (collectively referred to as send buttons 207), and a first set of tokens 208a and a second set of tokens 208b (collectively referred to as tokens 208). It should be understood that in accordance with some implementations, “tokens” may alternatively be referred to as coins or points without departing from the spirit and scope of the emobidments described herein.

Time counters 202 may keep time count for the players. For example, time counters 202 may be countdown timer devices. In some emboidments, the time counters 202 may be additionally be selectable (e.g., via touch) by the players. The players may mutually decide a time period each player will be allotted to form words and the time may be allotted on time counters 202. For example, each player may be allotted sixty seconds to form the words and time counters 202 may be set at sixty seconds. Time counters 202 may start counting down the allotted time when a player's turn begins and may count down towards zero. Time counters 202 may stop when either the player forms a word and selects a send button 207, or selects a time counter 202 or when a time counter 202 counter reaches zero. When a time counter 202 reaches zero before the player is able to form the word, the player may lose his turn. In an embodiment, time counters 202 may be used to pause the word game, trade turns, and end the word game. For example, the players may tap their respective time counters 202 to indicate an end of the turn, trade turns, and an end the word game.

In an embodiment, the allotted time for time counters 202 may depend on a level of difficulty for the game. For example, a beginner level may have relatively more allotted time than an expert level. As the difficulty level increases, the allotted time may decrease proportionally. In an embodiment, time counters 202 may begin counting up from zero at the beginning of the players turn, and stop when the player forms the word.

Misspelled counters 204 may keep a count of incorrect words formed by the players. For example, first misspelled counter 204a may keep track of the words misspelled by the first player and second misspelled counter 204b may keep track of words misspelled by the second player. In an embodiment, misspelled counters 204 may further keep track of a number of words missed by the players. For example, misspelled counters 204 may keep track of missed turns when the players were unable to form a word in the allotted time. Misspelled counters 204 may keep a separate counter for keeping track of missed turns or may include them in the misspelled word count. In an embodiment, misspelled counters 204 may show a hazard sign when the number of words misspelled by a player is above a predetermined number.

Medallions 206 earned by the players during the game may be tracked in the game environment 100. For example, the game environment 100 may keep track of first set of medallions 206a earned by the first player and second set of medallions 206b earned by the second player. The medallions 206 may be earned by the players during the game based on one or more defined achievements. These achievements may be predefined and may be depend on a difficulty level of the game. Medallions 206 may further be bought by the players. For example, the players may buy medallions 206 using tokens earned during the word game or by purchasing them.

Medallions 206 earned by a player may be used by the player as an advantage during the game. For example, a Missed Spell medallion may be used to remove one Missed Spell from misspelled counters 204 to allow a player to remain in contention. The Missed Spell medallion may be limited to be used only once per game and four uses per match. Players may purchase Missed Spell medallions for a predetermined number of tokens (e.g., 50 tokens).

As another example, a More Time medallion may be used to add additional time (e.g., 30 seconds of spelling time) to player's time counter 202. The More Time medallion may be limited to be used only once per game and four uses per match. Players may purchase More Time medallions for a predetermined number of tokens (e.g., 50 tokens).

As yet another example, a Confusion medallion may be used to impede opponent's ability to choose letters to build words for up to a predetermined time period (e.g., 30 seconds) by switching their letter with another from their letter pool. In an embodiment, the use of the Confusion may be limited to the first 50 seconds of an opponent's turn. The players may further be limited to use the Confusion medallion only once per game and twice per match. The players may purchase Confusion medallions for a predetermined number of tokens (e.g., 150 tokens).

As yet another example, a Lock Out medallion may be used to eliminate either player's ability to use medallions 206. In an embodiment, the Lock Out medallion may be limited to be used only once per game and four times per match. Players may purchase Lock Out medallions for a predetermined number of tokens (e.g., 200 tokens).

As yet another example, a Less Time medallion may be used to remove a predetermined amount of time (e.g., 15 seconds) from opponent time counters. In an embodiment, the Less Time medallions may be limited to for use only once per game and twice per match. Players may purchase Less Time medallions for a predetermined number of tokens (e.g., 150 tokens).

As yet another example, a Word Hint medallion may be used to suggest a minimum point word to a player based on their current letter pool to allow the player to remain in contention during play. In an embodiment, Word Hint medallions may be limited for use only once per game and three times per match. Players may purchase Word Hint medallions for a predetermined number of tokens (e.g., 200 tokens).

As yet another example, a Pause medallion may be used to pause a current player's game clock for a predeterimined time period (e.g., 30 seconds) to allow the player additional time to identify a word within their letter pool without increasing the amount of time the player would have to palce the letters on the game board 108. In an embodiment, Pause medallions may be limited for use only once per game and three times per match. Players may purchase Pause medallions for a predetermined number of tokes (e.g., 200 tokens).

As yet another example, a Flip Time medallion may be used to replace an opposing player's time clock (which may typically be 60 seconds) with a time period equivalent to the elapsed time that the opposing player used to form a previous word. In an embodiment, Flip Time medallions may be limited for use only once per game and three times per match. Players may purchase Flip Time medallians for a predetermined number of tokes (e.g., 200 tokens).

As yet another example, a Double Cross medallion may be used to give two consecutive turns to the player who chooses the medallion and then to the player's aopponent. In an embodiment, Double Cross medalliions may be limited for use only once per game and twice per match. Players may purchce Double Cross medaillions for a predetermined number of tokens (e.g., 200 tokens).

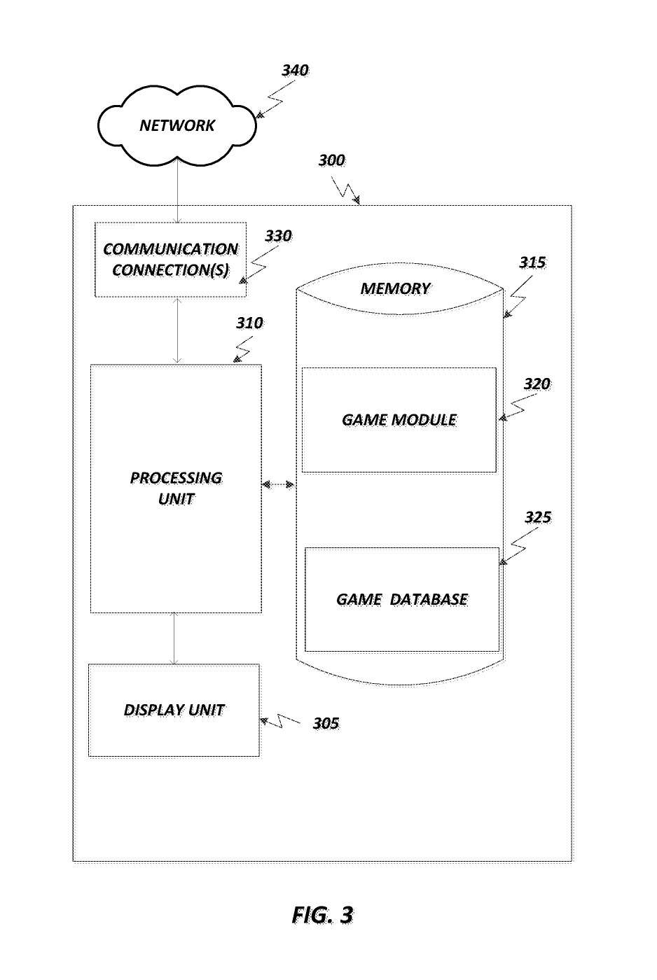

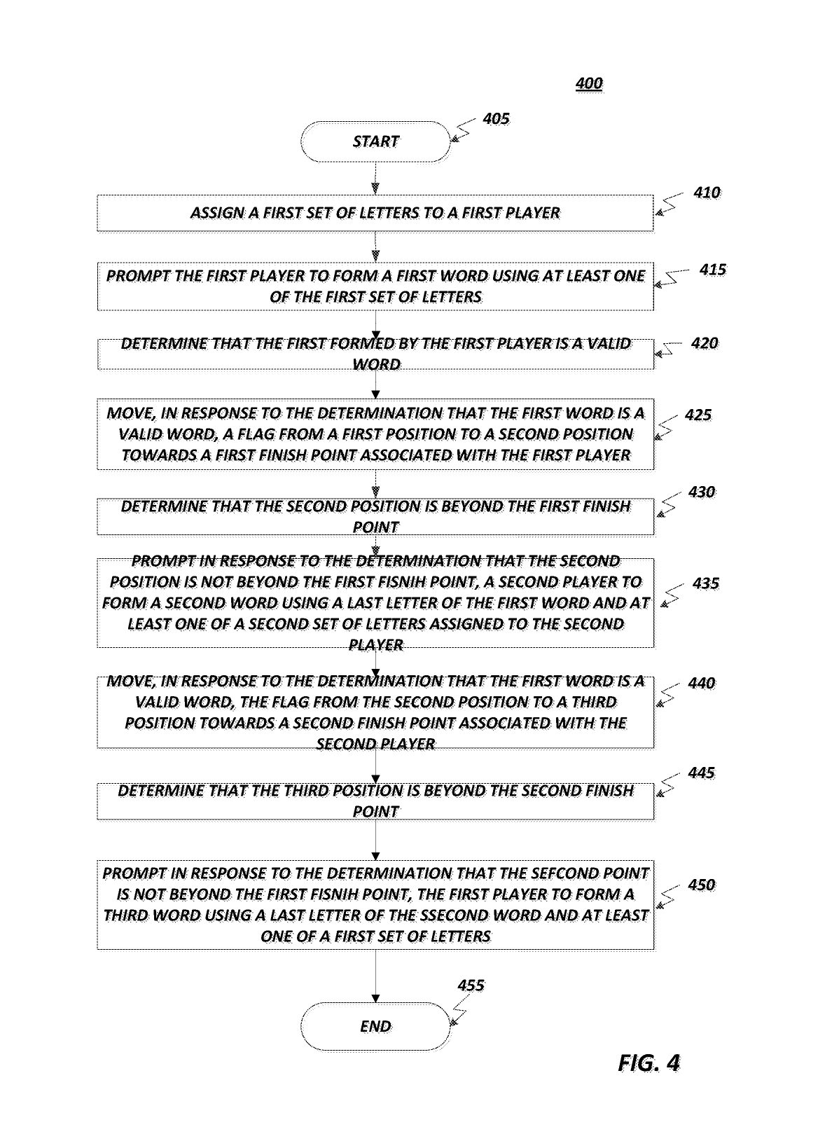

In an embodiment, the word game may be played on a computer system. For example, the word game may be implemented on a system 300 as shown with respect to FIG. 3. As shown in FIG. 3, system 300 may include a display unit 305, a processing unit 310, a memory 315 and one or more communication connections 330. Memory 315 may include a game module 320 and a game database 325. While executing on processing unit 310, game module 320 may present to one or more players on display unit 305, a user interface comprising elements of the word game and perform processes for facilitating the playing of the word game in one or more stages included in method 400 described below with respect to FIG. 4. The communication connections 330 may allowing communications with other computing devices (not shown) via either a direct connection or via network 340 which may comprise a local or wide area network (i.e., the Internet). Examples of suitable communication connections 330 may include, but are not limited to, RF transmitter, receiver, and/or transceiver circuitry; universal serial bus (USB), parallel, and/or serial ports.

System 300 may comprise, without limitation, a personal computer, a network computer, a mainframe, or other similar microcomputer-based workstation, a smartphone, a tablet personal computer, a laptop computer (or other mobile computing device) and the like. System 300 may further comprise a computing device within a distributed computing environment where tasks are performed by remote processing devices.

FIG. 4 is a flow chart setting forth the general stages involved in a method 400 consistent with an embodiment of the disclosure for playing the word game described with respect to FIGS. 1 and 2 above. Method 400 may be implemented using system 300 as described in more detail above with respect to FIG. 3. Ways to implement the stages of method 400 will be described in greater detail below. The outcome from the one or more stages of the method 400 may be displayed on display unit 305 or provided to an output means using an output interface of system 300.

Method 400 may begin at starting stage 405 where, for example, the first player may select the word game. The word game may be selected by activating an icon for the word game on system 300. Upon, the activation of the word game, the first player may be presented with a welcome message. The welcome message may include an introduction to the word game. For example, the welcome message may be “Weclome to TugaWords from DowsnStream Games!.” Another example of welcome message may include “Now you can experience thrilling and pressure filled word competition in a brand new way.” Yet another example of the welcome message may include “TugaWords invites you to challenge your friends to see who is the best.” The welcome message may be displayed using a graphical user interface and may be configured by an administrator or the players.

The introduction may include basic rules of the word game. An example introduction may include when play begins you will be awarded 12 letters. When prompted you will have sixty seconds to form a qualified word.” The introduction may include an option for the players to display additional information. The introduction welcome message may further include a plurality of options for the word game. For example, system 300 may prompt the first user to decide whether he wants to invite a second player. The first player may be provided with an option to invite the second player from his contact list or a social network. Upon selection of the second player option, system 300 may prompt the first player for a list of friends on a messaging service or on a social media. The first player may select the second player from the list. System 300 may then send an invitation to the second user to join the word game. The sent invitation may include identifying information of the first player. Once the second user joins the word game, system 300 may display the aforementioned welcome messages and introduction to the user as the second player. In an embodiment, the welcome message and the rules related to the word game may be skipped by the players.

Following stage 405, method 400 may proceed to stage 410 where a first set of letters may be assigned to the first player. For example, system 300 may assign a predetermined number of letters to the first player. The first set of letters assigned to the first player may be visible to the first player in first letter grid 102 as tiles. The first player may scroll first letter grid 102 to change relative positions of the tiles. The first player may be able to change positions of each tile individually as well as a group of tiles. In an embodiment, a second set of letters may be assigned to an opponent or a second player. For example, system 300 may assign the same number of letters to both the first and the second players. The second set of letters assigned to the second player may be visible to the second player in second letter grid 104 as tiles. The second player may also scroll second letter grid 104 to change relative positions of the tiles. It should be understood that the assigned first set of letters and the second set of letters may not be same. In an embodiment, system 300 may assign the first set of letters and the second set of letters to the first player and the second player substantially simultaneously. In another embodiment, system 300 may assign the first set of letters and the second set of letters to the first player and the second player one at a time. In yet another embodiment, system 300 may prompt the first player and the second player to draw the first set of letters and the second set of letters to the first player and the second player from a group of letters. While drawing, the group of letters will not be visible to the players.

After assigning the set of letters to the first player and the second player at stage 410, method 400 may proceed to stage 415 where the first player may be prompted to form a first word using the first set of letters. For example, system 300 may prompt the first player to form the first word on game board 106. A first letter of the first word may be placed at first start block 116a associated with the first player. In an embodiment, the first letter of the first word may be placed at a block corresponding to the neutral position on the number line and remaining letters of the first word may be placed towards first finish line 118a. First time counter 202a may be initiated substantially simultaneously with the first player being prompted to form the first word.

In an embodiment, the first player anytime during his turn, by tapping first time counter 202a, may enquire a remaining amount of time for his turn to form the word. For example, the first player may tap first time counter 202a and the remaining amount of time for forming the word may be announced by system 300. In another embodiment, the first user, by tapping first time counter 202a, may pause the word game. For example, when the first user taps first time counter 202a, an option for pausing the word game may be displayed. In addition to the option for pausing the word game, other choices, such as giving up a turn and ending the word game may be displayed. In an embodiment, the first player may be penalized for pausing the game or may be only allowed to pause the game for a predetermined period of time. First time counter 202a may further be used by the first player to signal the forming of the first word. For example, after forming the first word, the first player may tap first time counter 202a, and a display with send/submit option may be displayed. The first player may chose the send/submit option to submit the first word.

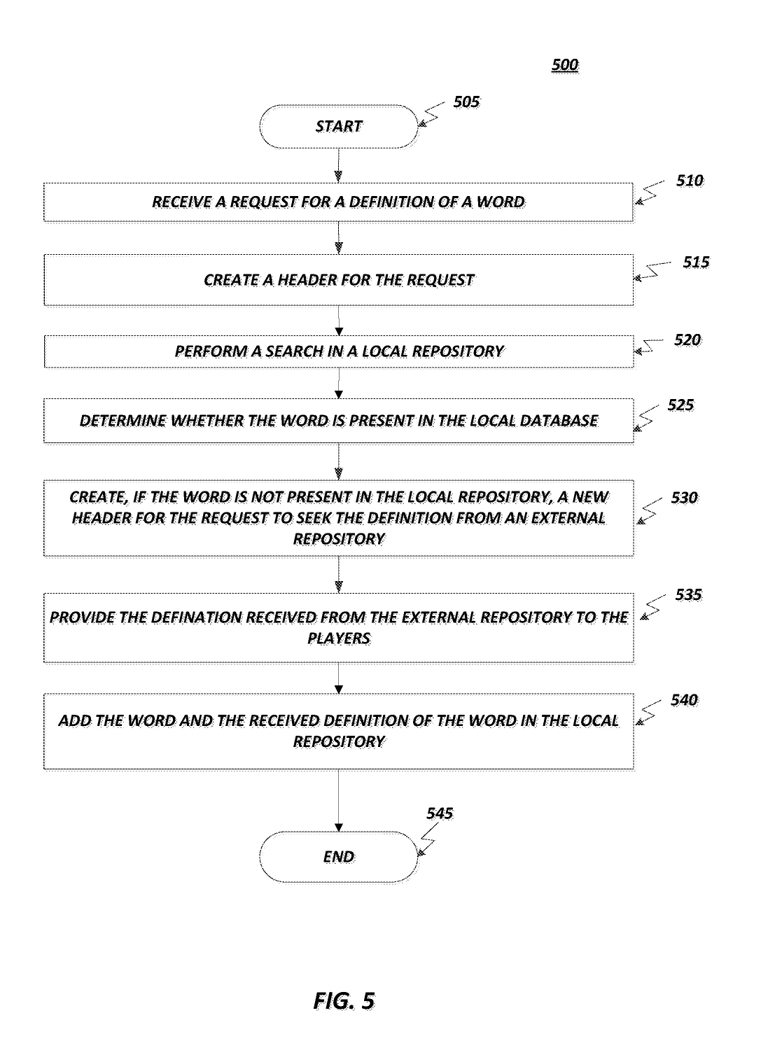

Once the first player has been prompted to form his word at stage 415, method 400 may proceed to stage 420 where validity of the first word formed by the first player may be determined. For example, for the first word to be a valid word, the first word should be defined in a standard dictionary and it should be spelled correctly as per the dictionary spelling. System 300 may determine the validity of the first word using a dictionary. For example, system 300 may have a local dictionary stored thereupon. A method to build a local dictionary is disclosed with reference to FIG. 5.

In an embodiment, before determining whether the first word is a valid word, system 300 may determine whether the first word was formed by the first player within the allotted time on first time counter 202a. If the first word was not formed within the allotted time, the first word may not be marked as a valid word. In addition, upon challenge by the second player, the first player may have to provide a definition of the first word. If the first player fails to provide the definition of the first word, the first word may be determined not to be a valid word. In an embodiment when the first word formed by the first player is determined to be not a valid word, the first player may be awarded a “no spell” and first misspelled counter 204a may be incremented by 1.

Once method 400 determined the validity of the first word formed by the first player at stage 420, method 400 may proceed at stage 425 where, in response to the determination that the first word is a valid word, flag 120 may be moved from a first position to a second position towards first finish line 118a. For example, once system 300 has determined that the first word is a valid word, as per the dictionary, points may be assigned to the first player. For example, system 300 upon determining that the first word was formed within the allotted time and is defined in the dictionary, may assign the points to the first player. The points may be assigned based on at least one of the following: a length of the first word, a time taken to form the first word, a complexity of the first word, type of letters used in forming the first word, etc. Flag 120, for example, based on the number of points earned by the first player, may then be moved towards first finish line 118a which may be associated with the first player. At the beginning of the word game, flag 120 may be placed at the neutral position as the first position. In response to the first player forming a valid word, flag 120 may be moved from the neutral position to the second position towards first finish line 118a.

In an embodiment, the second player, after the validity of the first word has been determined, may challenge the first player for providing definition of the first word. For example, the second player using his player interface may challenge the first player, and system 300 may prompt the first player to provide a definition of the first word. For example, system 300 may prompt the first player to provide the definition of the first word within a predetermined time. The predetermined time for providing the definition may be a predetermined or agreed upon time period.

In an embodiment, the first player may provide the definition for the first word by using a virtual keyboard, by speaking into a microphone, or by choosing a correct definition from a group of random definitions provided by system 300. The random definitions may include one correct definition and three or four incorrect definitions selected by system 300. If the definition provided by the first player is a correct definition, then the first player may be rewarded with extra points, medallions, or tokens. If the definition provided by the first player is an incorrect definition, penalties in form of points, medallions, or tokens may be imposed upon the first player. If the first player fails to provide the definition of the first word before the expiry of the predetermined time, the first player may concede his turn and no points for forming the first word may be awarded. In an embodiment, the first player may be provided only once chance or a predetermined number of chances for providing the definition of the first word.

In an embodiment, in addition to points, the first player may be assigned medallions 206. For example, after system 300 assigns medallions 206, they may be used strategically by the first player to gain an advantage in the word game. For example, the first player may use one of the medallions 206, in response to the first word being determined not to be a valid word, to get a second chance to form the first word. In addition, the medallions 206 may be used by the first player to create a disadvantage for the second player. For example, the first player, by using one of the medallions 206 may cause a reduction in the allotted time to form a word, for the second player.

The medallions 206 either may be earned by the players during the course of the word game based on one or more achievements or may be purchased by the players. The medallions 206 may include gold medallions which may be used to disable all medallions earned by the second player, silver medallions which may be used to pause the time counters, green medallions which may be used to gain additional time over the allotted time to form the word, blue medallions which may be used to receive tips on forming the word, red medallions which may be used to decrease the allotted time for the second player, yellow medallions which may be used to increase a number of games in a tournament, orange medallions which may be used to switch a set of letters assigned to the second player, no-spell medallions which may be used to decrement misspelled counters by one, and reload medallions which may be used to duplicate the medallions earned by the players. The above listed medallions are just examples of various types of medallions 206 which may be used in the game environment 100. Several other types of medallions may be used and created by an administrator of the game environment 100.

Once flag 120 has been moved at stage 425, method 400 may proceed to step 430 where method 400 may determine whether the second position is beyond first finish line 118a. For example, system 300 may determine whether in process of moving flag 120, first finish line 118a has been crossed. If flag 120 has crossed first finish line 118a, the first player may be declared as a winner of the word game and the players may be prompted with a message whether they want to continue playing another game. If the first player chooses not to continue playing another game, the word game may end.

At stage 435, in response to the determination that the second position is not beyond first finish line 118a, method 400 may prompt the second player to form a second word. For example, the second player may be prompted to form the second word using a last letter of the first word and at least one of the second set of the letters assigned to the second player. After the second player has formed the second word, system 300 may determine whether the second word formed by the second player is a valid word. Once system 300 has determined that the second word is a valid word, points may be assigned to the second player. The points may be assigned based on the second word formed by the second player. For example, the points may be assigned based on a length of the second word, a complexity of the second word, etc.

After assigning the points for forming the second word at stage 435, method 400 may proceed to stage 440 where flag 120 may be moved from the second position to a third position. For example, flag 120 may be moved from the second position to a third position towards second finish line 118b associated with the second player. Flag 120 may be moved for a second number of positions towards second finish line118b based on the second number of points. In an embodiment, flag 120 may be moved in direction opposite to first finish line 118a on the number line.

Once flag 120 has been moved to the third position at stage 440, method 400 may proceed at stage 445 where it may determine whether the third position is beyond second finish line 118b. For example, system 300 may determine whether the third position on the number line is beyond second finish line 118b. In an embodiment, if the third position is beyond second finish line 118b, the second player may be declared as the winner of the word game. Once the second player has been determined as the winner of the word game, system 300 may prompt the second player with an option to continue playing. If the second player choses the option to continue playing, system 300 may start a new word game.

After method 400 has determined, at stage 445, that the third position is not beyond second finish line 118b, it may proceed to stage 450 where method 400 may prompt the first player to form a third word. The first player may be prompted to form the third word using a last letter of the second word and the first set of letters in letter grid 102. In an embodiment, letters used by the first player to form the first word and the second player to form the second word may be replenished by system 300. For example, the letters used by the first player to form the first word may be replenished with random letters. After the first user has formed the third word, system 300 may move flag 120 based on the third word and determine if flag 120 has crossed first finish line 118a. If flag 120 has crossed the first finish line 118a, the first player may be declared as the winner. If flag 120 has not crossed first finish line 118a, the second player may be prompted to form a fourth word. The aforementioned steps may be repeated until one of the players has crossed one of finish lines 118 and/or is declared a winner. After the first player has been prompted to to form a third word word at stage 450, method 400 may end at stage 455.

In an embodiment, the winner may be determined by number of miss-spelled words entered by the players. For example, if any of the players misspells more than predetermined word in the word game, the opponent may be declared to be the winner of the word game. For example, if the first player misspells more than two words, the second player may be declared as the winner of the word game. In another embodiment, if any of the players fail to form a word in the allotted time for more than a predetermined number of times, the opponent may be declared as the winner of the word game. For example, if the first player is not able to form a word on more than two occasions within the allotted time, the second player may be declared as the winner of the word game. In yet another embodiment, the players may use medallions or tokens to reduce a number of misspelled or invalid word counts.

In an embodiment, system 300 may provide an expanded view of any of a number of components of the word game. For example, when tapped on letter grids 102 and 104, an expanded view of the letter grid may be provided. Similarly, upon tapping of a tile in in letter grids 102, 104, an expanded view of the tile may be provided. In another example, upon tapping of stats blocks 122 an expanded view of the player statistics may be provided.

In an embodiment, upon the completion of the word game, system 300 may upgrade rankings of each player. For example, system 300 may calculate a new ranking for the first player and the second player. System 300 may add ranking points to the winner of the word game and/or deduct ranking points from the loser of the word game. The ranking points may be based on a plurality of criteria, such as difference in rankings between the first player and the second player, the overall time of completion of the word game, a speed of forming the words in the word game, etc. In addition, to upgrading the ranking points, system 300 may also upgrade the statistics associated with both the first player and the second player. Moreover, system 300 may provide the players with an option to share/and or publish the results of the word game or upgraded rankings on social media. In an embodiment, system 300 may provide with an option of providing a live update of the word game on the social media. The live update may include each word formed by the players, points, medallions, or tokens earned by the players, etc. In an embodiment, a live feed of the updates may be provided to friends of the players on the social media.

FIG. 5 is a flow chart setting forth the general stages involved in a method 500 conistent with an embodiment of the disclosure for creating and maintaining a local repository for the definitions utilized in playing the word game described with respect to FIGS. 1 and 2 above. For example, system 300 may create and maintain the local repository of words and corresponding definitions used or likely to be used by the players. A size of the local repository may be predefined in terms of storage space or number of words. For example, the size of the local repository may be defined to not to exceed more than 10 megabytes of data or 200,000 words. In an embodiment, the local repository may either be maintained on system 300 or in a cloud accessible to system 300. For example, the local repository maintained on system 300 may be limited to the predefined size containing frequently used words, and a bigger repository may be maintained in the cloud.

Method 500 may begin at stage 505, and proceed to stage 510 where system 300 may receive a request for a definition of a word formed by a player. The request may be received in response to a challenge by the opposite player or by the player who formed the word. After receiving the request at stage 510, method 500 may proceed to stage 515 where a header for the request may be created. For example, the header for the request may be created to seek definition of the word. The header may be created using a hypertext transport protocol (HTTP) or other protocols compatible with system 300.

Once the header is created at 515, method 500 may proceed to stage 520 where a search may be performed in the local repository. For example, using the header a lookup may be performed in the local repository to locate the word. After performing the search at stage 520, method 500 may proceed to stage 525 where system 300 may determine whether the word is present in the local repository. For example, system 300 may analyze results of the lookup operation to determine whether the word, and the corresponding definition of the word, is present in the local repository. In response to determining that the word and the definition of the word is present in the local repository, system 500 may provide the definition to the player.

In response to determining that the word or definition of the word is not present in the local repository at stage 525, method 500 may proceed to stage 530 where a new header for the request may be created. For example, the original header for the request may be modified to seek the definition of the word from an external database. The original header may be modified to seek the definition of the word from a known external database, such as a publically available dictionary or a dictionary system 300 has access to.

Once the header has been modified to seek the definition of the word from an external database at stage 530, method 500 may proceed to stage 535 where the definition of the word received from the external database may be provided to the player. After providing the definition of the word to the players at stage 535, method 500 may proceed to stage 540 where the definition may be added to the local repository. For example, an entry to the word, if not present, may be created in the local repository and the definition may be added in the entry. In an embodiment, before adding the word to the local repository, system 300 may prompt the user informing adding of the word to the local repository. After the word and the definition of the word has been added to the local repository at stage 540, method 500 may end at stage 545.

In an embodiment, if the local repository is limited by number of words or data that can be stored on system 300, the words may be recycled based on a frequency of use. For example, more frequently words may replace less frequently words in the local repository.

In an embodiment, the word game described herein may be played as a tournament. For example, system 300 may create tournament for a group of players. In another embodiment, system 300 may create a tournament for students of a class. In the tournament each player may proceed to a next round by defeating his/her opponent in the previous round. The players for the tournament may be selected from a social media. For example, system 300 may create a tournament for a group on the social media. The system 300 may further create a tournament for members of the social media even if they are not part of a group. For example, system 300 may create a tournament for the word game based on the ranking of the members of the social media. In another example, system 300 may create an assignment for a group of students based on the word game. The assignment may be individual assignment, wherein each student is assigned to achieve certain score against system 300, or as a class assignment wherein students are assigned to compete with fellow students.

In another embodiment, system 300 may host the word game on social media. For example, game board 106 may be hosted on social media as an application of the social media or operating system associated with system 300. The word game may also be hosted on a cloud service to reduce a memory usage of system 300. When hosted on the social media or the cloud service, words may be submitted by the players by using messaging services, such as short messaging service (SMS) or a web-based messenger service. In some embodiments, system 300 may be configured to support more active users as a comparable word game while requiring only a small percentage of bandwidth.

In some embodiments, game module 320 in the system 300 may be optimized to take up less memory space (e.g., less than fifty percent) of the memory storage space of comparable application programs. In some embodiments, game module 320 may further be configured to communicate between computing devices utilizing small data transmissions (i.e., comparable to less than the size of an SMS message). In some embodiments, game module 320 may be configured to have low memory and processor requirements on mobile computing devices, thereby increasing battery life during game play while also allowing for full functionality of other mobile computing device functions. For example, while the word game is being played on a mobile computing device, telephone calls, text messages and other mobile computing device features may continue to operate without interruption. In an embodiment, game module 320 may be configured for compatibility with advanced Internet markup languages, such as HTML5 which provides multimedia support while also being capable of running on low-powered devices such as smartphones and tablets.

Embodiments of the disclosure, for example, may be implemented as a computer process (method), a computing system, or as an article of manufacture, such as a computer program product or computer readable media. The term computer readable media as used herein may include computer storage media. Computer storage media may include volatile and nonvolatile, removable and non-removable media implemented in any method or technology for storage of information, such as computer readable instructions, data structures, or program modules. Memory 315 (described above with respect to FIG. 3) is an example of a computer storage media (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the system 300. Any such computer storage media may be part of the system 300. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method of playing a word game comprising:
receiving a first word formed by a first player using at least one of a first set of letters assigned to the first player;
determining that the first word formed by the first player is a valid word;
moving in response to the determination that the first word is the valid word, a flag from a first position to a second position towards a first finish line associated with the first player based on the first word formed by the first player;
determining whether the second position is beyond the first finish line;
receiving, in response to the determination that the second position is not beyond the first finish line, a second word formed by a second player using a last letter of the first word and at least one of a second set of letters;
moving, based on the second word formed by the second player, the flag from the second position to a third position towards a second finish line associated with the second player;
determining whether the third position is beyond the second finish line; and
receiving, in response to the determination that the second position not beyond the second finish line, a third word formed by the first player using a last letter of the second word and at least one of the first set of letters.

2. The method of claim 1, wherein receiving, in response to the determination that the second position not beyond the second finish line, a third word formed by the first player, comprises: replacing the at least one of the first set of letters used by the first player to form the first word.

3. The method of claim 1, wherein determining that the first word formed by the first player is the valid word comprises determining that the first word is defined in a dictionary.

4. The method of claim 1, wherein moving the flag from the first position to the second position towards the first finish line comprises moving the flag on a number line from a neutral position to the second position in a first direction.

5. The method of claim 4, wherein moving the flag from the second position to the third position comprises moving the flag in a second direction opposite to the first direction on the number line.

6. The method of claim 1, wherein receiving the second word formed by the second user comprises:
prompting the first player to send an invitation to the second player;
assigning, upon acceptance of the invitation by the second player, the second set of letters to the second player; and
prompting the second user to form the second word using the last letter of the first word and the at least one of the second set of letters.

7. The method of claim 6, wherein prompting the first player to send the invitation to the second player further comprises providing an option to the first player to choose the second player from a friends list.

8. The method of claim 1, further comprising:
assigning medallions to the first player and the second player.

9. The method of claim 8, wherein assigning the medallions to the first player and the second player comprises assigning the medallions to the first player and the second player, the medallions being utilized to gain an advantage over at least one of the first player and the second player.

10. The method of claim 1, wherein the first set of letters and the second set of letters are comprise lenticular print.

11. A computing device for playing a word game comprising:
a memory for storing an executable program module; and
a processor, functionally coupled to the memory, the processor being responsive to computer-executable instructions contained in the program module and operative to:
display, a graphical user interface (GUI) comprising a game board, the game board comprising a first section and a second section, wherein the first section comprises a first predetermined number of slots including a start block, and wherein the second section comprises a number line, a neutral point, a first finish line, a second finish line, and a flag;
display, in the GUI, a first player interface comprising a first set of predetermined letters;
wherein the GUI is configured to:
assign a first set of letters to a first player, wherein the first set of letters are visible to the first player in the first player interface;
prompt the first player to form a first word on the game board using at least one of the first set of letters;
determine that the first word formed by the first player is a valid word;
move, in response to the determination that the first word is the valid word, the flag from the neutral position to a second position towards the first finish line based on the first word formed by the first player;
determine whether the second position is beyond the first finish point;
prompt, in response to the determination that the second position is not beyond the first finish line, the second player to form a second word using a last letter of the first word and at least one of a second set of letters;
move, based on the second word formed by the second player, the flag from the second position to a third position towards the second finish line on the number line;
determine whether the third position is beyond the second finish line; and
prompt, in response to the determination that the second position not beyond the second finish line, the first player to form a third word using a last letter of the second word and at least one of the first set of letters.

12. The computing device of claim 11, wherein the first finish line and the second finish line are located equidistant from the neutral point in opposing direction.

13. The computing device of claim 11, wherein the game board further comprises a time counter, wherein time counter is configured to count a time taken by the first player to form the first word.

14. The computing device of claim 11, wherein the game board further comprises a misspelled counter wherein the misspelled counter is configured to display a number of words misspelled by the first player.

15. The computing device of claim 14, wherein the misspelled counter is further configured to display the number of words misspelled by the second player.

16. The computing device of claim 11, wherein the GUI is further configured to display medallions earned by the first player.

17. A computer readable medium which stores a set of instructions which when executed performs a method of playing a word game, the method executed by the set of instructions comprising:
assigning a first set of letters to a first player;
prompting the first player to form a first word using at least one of the first set of letters;
determining that the first word formed by the first player is a valid word;
moving, in response to the determination that the first word is the valid word, a flag from a first position to a second position towards a first finish line associated with the first player based on the first word formed by the first player;
determining whether the second position is beyond the first finish line;
prompting, in response to the determination that the second position is not beyond the first finish line, the second player to form a second word using a last letter of the first word and at least one of a second set of letters;
moving, based on the second word formed by the second player, the flag from the second position to a third position towards a second finish line associated with a second player;
determining whether the third position is beyond the second finish line; and
prompting, in response to the determination that the second position not beyond the second finish line, the first player to form a third word using a last letter of the second word and at least one of the first set of letters.

18. The computer readable medium of claim 17, wherein the instructions are executed on a mobile computing device.

19. The computer readable medium of claim 17, wherein the second player is a computer system.

20. The computer readable medium of claim 17, further comprising:
receiving, upon formation of the second word, a challenge from the first player, the challenge comprising a prompt for the second player to provide a definition for the second word; and
providing, upon acceptance of the challenge, a prompt for selecting a correct definition for the second word from a plurality of definitions.
